(19) United States
(12) Patent Application Publication
(10) Pub. No.: US 2009/0211160 A1
(43) Pub. Date: Aug. 27, 2009

(54) ACCESS DEVICE WITH A PHOTOVOLTAIC HOUSING UTILIZED TO GENERATE POWER

(76) Inventor: Ali Tehranchi, New Port Coast, CA (US)

Correspondence Address: JAFARI LAW GROUP, P.C., 801 N. PARKCENTER DRIVE, SUITE 220, SANTA ANA, CA, 92705, US

(21) Appl. No.: 12/037,582

(22) Filed: Feb. 26, 2008

(51) Int. Cl. E05F 15/00

(52) U.S. Cl. 49/360; 49/324

(57) ABSTRACT

The invention is an access operating device equipped with a photovoltaic housing, and in particular, an access device, for example a movable barrier operator, equipped with a housing, which has been retrofitted with a photovoltaic substrate or film, and adapted to convert energy, for example solar energy, to an electrical power source for powering the movable barrier operator or access operating device. The photovoltaic housing is used to draw light energy and convert it to an electrical power supply for the operator's various devices, for example, a controller and motor.

### COPYRIGHT & TRADEMARK NOTICE

A portion of the disclosure of this patent application may contain material that is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and shall not be construed as descriptive or to limit the scope of this invention to material associated only with such marks.

### TECHNICAL FIELD OF THE INVENTION

This invention relates generally to an access operating device equipped with a photovoltaic housing, and in particular, an access device, for example a movable barrier operator, equipped with a housing, which has been retrofitted with a photovoltaic substrate or film, and adapted to convert energy, for example solar energy, to an electrical power source for powering the movable barrier operator or access operating device.

### BACKGROUND OF THE INVENTION

In the access system industry, equipment is built and designed to control access to an area using, for example, a gate. Naturally, both simple and complex systems may require the use of electrical power to actuate the various components often implemented with access systems, for example: to generate power for a motor to actuate a movable barrier, for sensors to detect events, for alarms to send signals, or for separate systems to communicate.

Generally, an installer needs to cut grooves into concrete or pavement for all the power lines to run between two or more machines in a particular power grid, which can be very expensive depending on the premises. In some cases, such as in remote areas, extensive resources must be spent to provide power to properly run an access system. This causes a further strain on the manufacturers, the surrounding community, as well as the environment.

Furthermore, in order to safely power the various devices that may comprise an access system, for some applications, power lines are sometimes insulated and configured in such a manner so as to prevent interference with the communication wires that are often utilized, for example to send signals between sensors and controllers. Expensive installation and maintenance is required since such wires may become vulnerable to issues such as oxidation in the junctions, breakage, or intermittent false contacts. The magnetic and electric fields emitted from the power lines create noise, which may interfere with the signals that may be transmitting between machines. If an installer is unable to use separate conduits for supplying power and for supplying communication signals, the low voltage wires running in parallel could cause noise so severe that communication signals may be corrupted, or communication signals could be completely blocked or erased.

Presently, the art has been unable to adequately solve this problem. There is a need in the art for an access system that eliminates the need of power lines or wires to supply access systems with a constant energy source that is efficient, cost effective, and most importantly, that provides a means to tap into a clean, environmentally friendly power source. It is to these ends that the present invention has been developed.

### SUMMARY OF THE INVENTION

To minimize the limitations found in the prior art, and to minimize other limitations that will be apparent upon the reading of the specification, the present invention provides an access operating device equipped with a photovoltaic housing, which has been retrofitted with a photovoltaic film and adapted to convert energy, for example solar energy, to an electrical power source for powering an access operating system.

A movable barrier operator, which moves the barrier from an open position to a closed position and vice-versa, is housed with a cover that has been treated with a photovoltaic film. The photovoltaic film is used to draw light energy and convert it to an electrical power supply for the operator's various devices, for example, a controller and motor.

An access system in accordance with the present invention comprises a movable barrier, a sensor, a motor mechanically coupled to said movable barrier, a controller adapted to send a control signal to said motor to move said movable barrier in response to a sensing signal received from said sensor, a battery adapted to supply power to said controller and said motor; and a housing for enclosing at least said controller, said motor and said battery, wherein an external surface of said housing includes a photovoltaic film adapted to supply power to said battery, said controller and said motor.

A movable barrier operator for an access system, in accordance with the present invention, comprises a first connector adapted to connect to a sensor, a motor adapted to be mechanically coupled to a movable barrier, a controller adapted to send a control signal to said motor to actuate said movable barrier in response to a sensing signal received from said sensor, a battery adapted to supply power to said controller and motor; and a housing for enclosing at least said controller, motor and battery, wherein an external surface of said housing includes a photovoltaic film adapted to supply power to said battery, said controller and said motor.

A housing for an access system operator, in accordance with the present invention, comprises a casing, a photovoltaic film disposed on at least a portion of an external surface of said casing, and a connector adapted to route power from said photovoltaic film to one or more devices enclosed within the casing.

It is an objective of the present invention to provide an alternative source of electrical power for access systems.

It is another objective of the present invention to provide a unique configuration of movable barrier operator components and a photovoltaic power supply for delivering electrical power to access systems.

It is another objective of the present invention to utilize an environmentally friendly approach for powering access systems.

It is yet another objective of the present invention to provide efficient power supply to access systems in remote areas without the costly installment of power lines and grids.

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. The drawings are generalized in form in the interest of clarity and conciseness.

FIG. 1 is a block diagram of one embodiment of the present invention, illustrating the various components of an access system which draws energy from a photovoltaic power source.

FIG. 2 is a block diagram schematic of an embodiment of one gate operator, which utilizes a housing modified with a photovoltaic cover to draw power for its various components, in accordance with the present invention.

FIG. 3 is a diagram illustrating one embodiment of an access system's movable barrier operator housing, in accordance with the present invention, which comprises a metal and plastic cover that has been treated with a photovoltaic film to provide power to the operator's various components.

FIG. 4 is an illustration of one embodiment in accordance with the present invention, which comprises of a sliding gate powered by a photovoltaic source coupled to the sliding gate operator.

FIG. 5 illustrates the various components of an exemplary embodiment of an access system's movable barrier operator in accordance with the present invention, which may be used with sliding movable barriers such as sliding gate 403.

FIG. 6(a) illustrates an embodiment of the present invention in which a photovoltaicly powered movable barrier operator utilizes a chain to actuate a slide gate, comprising an operator housing treated or printed with photovoltaic film to generate an electrical power source.

FIG. 6(b) is an illustration of movable barrier 600 with housing 601 properly in place.

FIG. 7 illustrates an embodiment of the present invention in which a photovoltaicly powered movable barrier operator utilizes an articulated arm to actuate a swing gate, comprising an operator housing treated or printed with photovoltaic film to generate an electrical power source.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the invention.

In the following detailed description, an access system is a system of one or more movable barriers positioned on any premises to provide access in or out of said premise, for example into a neighborhood, a building, a large compound, a small residence, an industrial site, an agricultural site, a roadway system, a parking structure, or any other type of premise for which controlled access may be desired. An access system may also include controlled access systems for airways, waterways, or even pipelines that control fluid or gas flow.

A movable barrier operator, or gate operator, can be any system that controls a barrier to an entry, an exit, or a view. The barrier could be a door for a small entity (i.e. a vehicle), or a gate for a large entity (i.e. a building) which can swing out, slide open, pivot, fold or even roll upwards.

An operator in accordance with the present invention, which moves the barrier from an open position to a closed position and vice-versa, is housed with a cover that has been treated with a photovoltaic film. The photovoltaic film is used to draw light energy and convert it to an electrical power supply for the operator's various devices, for example, a controller and motor.

In an exemplary embodiment, a photovoltaic cover for a movable barrier provides power to external accessories. For example, and without limiting the scope of the present invention, a photovoltaic cover may be used to power keypads, photoelectric beams, and radio receivers.

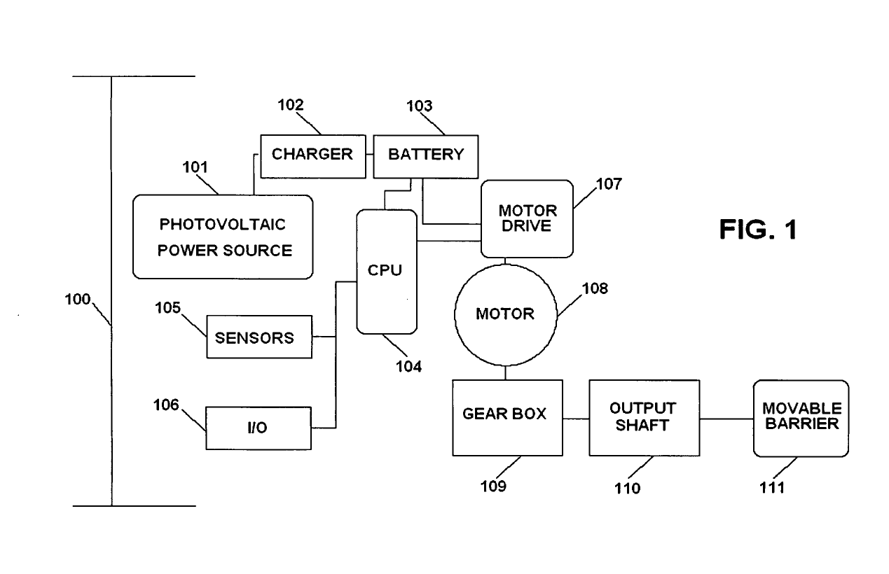

FIG. 1 is a block diagram of one embodiment of the present invention, illustrating the various components of an access system which draws energy from a photovoltaic power source. Access system 100 comprises photovoltaic power source 101, charger 102, battery 103, CPU 104, sensors 105, input/output device 106, motor drive 107, motor 108, gear box 109, output shaft 110, and movable barrier 111.

Access system 100 derives power from photovoltaic power source 101. Generally, photovoltaic power source 101 draws power from a light source, for example sun light, and converts that energy to an electrical power source that is then fed to components of access system 100; in this case, charger 102, motor drive 107, and CPU 104.

Battery 103 draws power from charger 102, and uses that power to supply energy to other components. In one embodiment, battery 103 may serve as a back-up device, and may provide power to both motor drive 107 and CPU 104 should power become unavailable from photovoltaic power source 101. Generally, however, CPU 104 and motor drive 107 are powered by photovoltaic power source 101.

Charger 102 draws power to charge battery 103, however in one embodiment, charger 102 serves to control a voltage level as well. For example, and without deviating from the scope of the present invention, it may be desirable to connect photovoltaic power source 101 directly to a voltage regulator so as to prevent damage to the various components while providing a power supply.

Motor drive 107 controls motor 108, and can receive and respond to commands from CPU 104. In alternate embodiments, different configurations for access system 100 may be implemented without departing from the scope of the present invention. For example, motor drive 107 and motor 108 may comprise the same device, and battery 103 could be eliminated. However, it may be undesirable to eliminate battery 103 since there may be applications in which a light source is limited or becomes scarce during long periods of time when a back-up power supply is necessary.

Sensors 105 monitor events occurring related to movable barrier 111, and send command signals to CPU 104 that monitor and control actuation of motor drive 107 and motor 108. Sensors 105 may be any type of known sensors without deviating from the scope of the present invention. For example, sensors 105 may be loop induction sensors, infra-red sensors, photosensitive sensors, motion sensors, or any other sensors that may be desirable in a particular access system configuration.

CPU 104 controls the actions of access system 100 by communicating with motor drive 107, input/output device 106, and sensor 105. CPU 104 may be any type of controller unit known in the art suitable to perform the various commands necessary in the access system industry such as controlling travel limits, actuation speeds, sensor sensitivity levels, power regulating functions, or any other similar function commonly practiced in access systems, without deviating from the scope of the present invention.

Input/output device 106, gear box 109, and output shaft 110 are other typical components that may be used with an access system powered by photovoltaic power source 101. For example, input/output device 106 may be a monitoring device that may be momentarily connected to access system 100 by an installer or maintenance personnel. Such monitoring device, for example, may provide diagnostics information to such personnel regarding photovoltaic power source 101.

In one embodiment, input/output device 106 is a diagnostics monitoring tool that draws power from photovoltaic power source 101 upon connecting to access system 100, and provides information about the various parameters and functions available that control movable barrier 111.

In another embodiment, input/output device 106 is a keypad powered by photovoltaic power source 106, which provides a security feature to access system 100.

Typically, photovoltaic power source 100 is a collection of power cells interconnected via a conduit or matrix that provide a source of power from the sun. However, photovoltaic power source 101 may comprise any type of photovoltaic materials capable of converting multiple types of light to a source of electrical power, without deviating from the scope of the present invention.

In one embodiment, photovoltaic power source 101 is a single-crystal, single layer p-n junction diode, capable of generating usable electrical energy from light sources with the wavelengths of sunlight.

In another embodiment, photovoltaic power source 101 comprises a device based on the use of thin epitaxial deposits of semiconductors on lattice-matched wafers or a thin-film technology. One advantage of utilizing this technology is reduced mass so it allows fitting panels on light or flexible materials, for example, textiles or plastics that may be implemented in the components of the movable barrier operator.

In yet another embodiment, photovoltaic power source 101 includes composite photovoltaic technology. That technology comprises of polymers with nano particles that can be mixed together to make a single multi-spectrum layer. This type of photovoltaic device is more efficient and cost effective, consisting of layers that convert different types of light including infrared light. This provides an added advantage since photovoltaic power source 101 would not necessarily require direct sunlight to provide access system 100 with electrical power.

In future access systems, as technology becomes economically viable, photovoltaics may be yet more efficient than current semiconductor devices. Examples of such devices include quantum well devices (such as quantum dots, or quantum ropes) and devices incorporating carbon nano-tubes.

The present invention may utilize any photovoltaic device that may be implemented into photovoltaic power source 101, including photoelectron-chemical cells, polymer solar cells, nano-crystal solar cells, Dye-sensitized solar cells, or any other type of photovoltaic cell, substrate, film, or photovoltaic material, without deviating from the scope of the present invention.

Thus, while photovoltaic power source 101 may utilize many types of photovoltaic materials, a thin, flexible photovoltaic substrate or film may be desirable over the other various embodiments of photovoltaic power source 101.

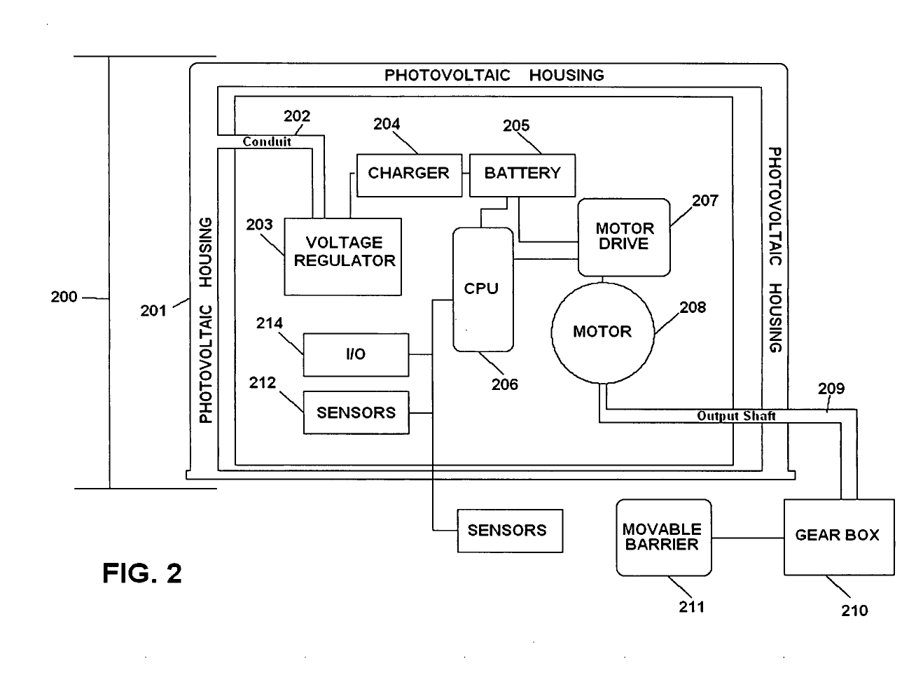

FIG. 2 is a block diagram schematic of an embodiment of one gate operator, in accordance with the present invention, which utilizes a housing modified with a flexible photovoltaic film to draw power for its various components.

Movable barrier operator 200 comprises of housing 201, conduit 202, voltage regulator 203, charger 204, battery 205, CPU 206, motor drive 207, and motor 208. Additional components may also be installed to communicate with motor drive 207 and motor 208, such as sensors 212, and input/output device 214.

Typically, output shaft 209 extends from movable barrier operator 200's motor 208 and mechanically connects to gear box 210. However, output shaft 209 may be directly coupled to movable barrier 211, or an articulated arm (not shown) or any other type of drive mechanism that will engage and actuate movable barrier 211.

Housing 201 may be constructed of a variety of materials and components. For example, in one embodiment, housing 201 is constructed of a strong light-weight plastic. In another embodiment, housing 201 is constructed of a durable stainless metal.

Housing 201 is typically treated with a photovoltaic film applied to its surface. In one embodiment, a photovoltaic film is directly applied to a plastic cover placed on top of housing 201. In another embodiment, housing 201 is constructed of a photovoltaic material itself. In an exemplary embodiment housing 201 comprises an inner frame structure to securely hold movable barrier operator 200's components, and an outer plastic cover wherein a photovoltaic film or substrate is applied to its cover component.

The photovoltaic film may be constructed of any type of photovoltaic material that allows housing 201 to supply an electrical power source to movable barrier 200's components. For example, and without limiting the scope of the present invention, the photovoltaic film or material comprises a lightweight, flexible plastic nano-enabled polymer photovoltaic material substrate. This may be more desirable over other conventional methods of applying photovoltaic cells on surfaces, such as applying photovoltaic cells or modules on a glass surface; that method, although within the scope of the present invention, fails to provide flexibility, which may be preferred for durability and versatility purposes.

In an exemplary embodiment, housing 201 comprises of photovoltaic nano-materials which can utilize a wider range of the light spectrum, capable of absorbing visible and invisible light sources, (i.e. light other than sunlight), to generate an electrical power source for movable barrier 200. An example of such technology is the nano-enabled polymer photovoltaic materials developed by Konarka.™

This embodiment may be particularly desirable for low light or even indoor applications that may be less exposed to natural lighting. Furthermore, such embodiment would be able to capture reflective light and discard the need for an additional device adapted to constantly point housing 201 towards the sun.

Typically, light energy traveling through the electrically active materials and electrode matrix on housing 201's surface is converted into electrical energy. Conduit 202 then delivers the electrical energy generated by housing 201's photovoltaic film matrix to voltage regulator 203, where the voltage entering movable barrier 200's components, is regulated.

Voltage regulator 203 may be desirable to prevent battery 205 from draining, or over charging or to prevent damage to the various components, for example CPU 208 may be overloaded or input/output device may not be properly powered.

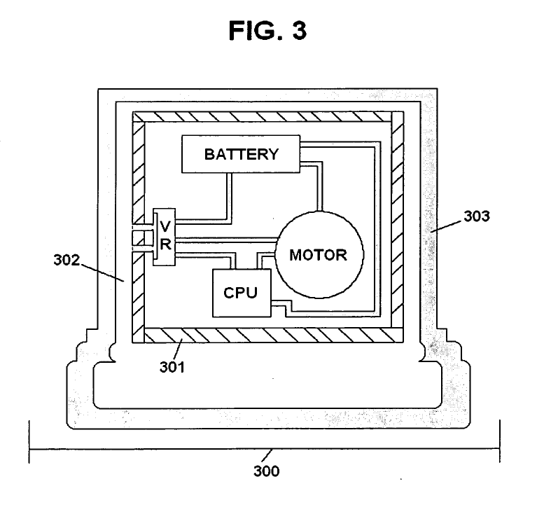

FIG. 3 is a diagram illustrating one embodiment of an access system's movable barrier operator housing, in accordance with the present invention, which comprises an inner rigid frame structure and a plastic cover that has been treated with a photovoltaic film to provide power to the operator's various components. The diagram shows the various layers that allow housing 300 to securely contain a movable barrier operator's components, and provide the necessary electrical power source.

Housing 300 comprises of an inner rigid frame structure 301. Rigid frame structure 301 may be a metal frame, a hard plastic frame, or any other rigid material able to securely hold delicate components such as a motor or controller.

Covering rigid frame structure 301 is cover 302, which provides a layer of a light-weight material on which photovoltaic film 303 may be disposed. Cover 302 may be a thin simple cover to provide protection from the elements, or may further include reinforced portions for affixing housing 300 on a particular surface or structure.

Photovoltaic film 303 may be disposed or applied over an entire surface of cover 302, or a partial surface of cover 302, depending on its exposure to light sources. In an exemplary embodiment, cover 302's exposed surface is completely covered with photovoltaic film 303 for optimizing electrical power generation.

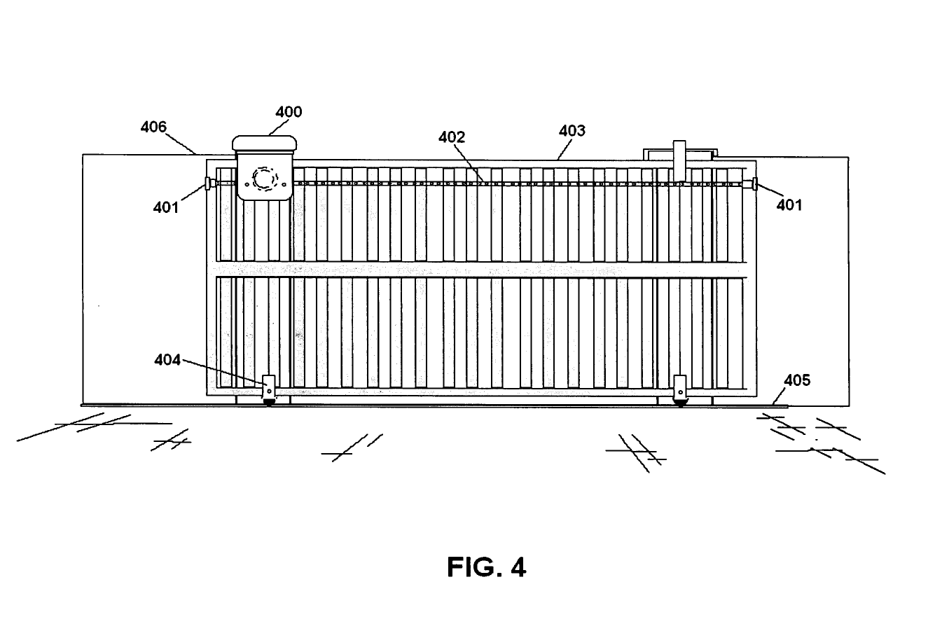

FIG. 4 is an illustration of one embodiment in accordance with the present invention, which includes a sliding gate powered by a sliding gate operator comprising a photovoltaic housing.

The illustrated embodiment comprises gate operator 400, gate 403, chain links 401 chain 402, wheels 404, track 405, and gate support structure 406. Gate operator 400 is mechanically coupled to gate 403 by fixing gate operator 400 so that it is mechanically connected with chain 402. In this exemplary embodiment, FIG. 4 shows the positioning of gate operator 400 at a top corner of gate 403, attached to gate support structure 406 in a manner so that gate operator 400 hangs over gate 403 to mechanically direct movement of chain 402. Gate support structure 406 is typically a wall which serves as a stationary barrier to further the control of a particular access point to a premise.

Alternatively, gate operator 400 may be coupled in any way as long as it is able to actuate gate 403 in a horizontal plane from an open position to a close position. However, it may be desirable to place gate operator 400 on a high position so as to allow gate operator 400 more exposure to light. For example, placing gate operator 400 near a ground position may subject gate operator 400 to shadows created by gate support structure 406.

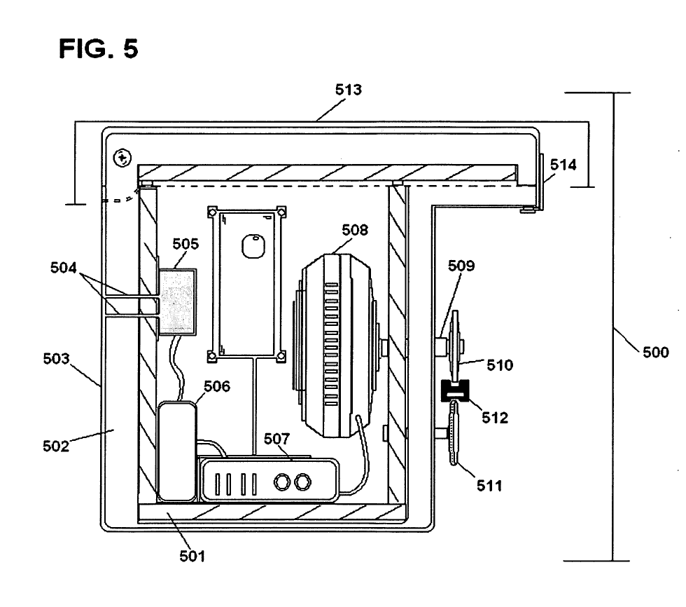

FIG. 5 illustrates the various components of an exemplary embodiment of an access system's movable barrier operator in accordance with the present invention, which may be used with sliding movable barriers such as sliding gate 403.

Gate operator 500 comprises of an inner metal frame 501 for securing controller 507, rechargeable battery 506, voltage regulator 505 and motor 508. Frame 501 may also be used to secure other devices which may be implemented with gate operator 500, for example, an infra red sensor component.

Frame 501 is encased by housing 502 which is typically made of a tough, inexpensive plastic material. Housing 502 is treated or printed with photovoltaic film 503. Photovoltaic film 503 contains electrode matrix 504, which travels through the photovoltaic substrate (of photovoltaic film 503) into the inner portion of frame 501 to deliver an electrical power source via voltage regulator 505.

When photovoltaic film 503 is exposed to light, energy traveling through electrically active materials and electrode matrix 504, power up battery 506. Battery 506 supplies power to controller 507 which communicates proper parameters for motor 508 to turn output shaft 509 and rotate sprocket 510. Sprocket 510, being mechanically coupled to chain link 512, will rotate on either direction depending on the parameters set by controller 507.

As chain link 512 is moved laterally in either direction, a gate such as gate 403, which is connected to chain 402 with chain connectors 401, will slide from an open position to a close position and vice-versa. Chain link 512 is kept aligned, as well as the other links in the chain (not shown), by guiding wheel 511 in order to keep gate operator 500 mechanically linked to a slide gate such as slide gate 403.

Gate operator 500 may be serviced and maintained by accessing its various components through lid 513 of housing 502. By unlatching latch 514, and opening lid 513, any of the secured devices within housing 502 may be accessed.

Furthermore, this compact design may house several types of small motors. Motor 508 may be an AC motor, a DC motor, a Brushless motor, a Lorentz force motor, or any other motor known in the art, without deviating from the scope of the present invention.

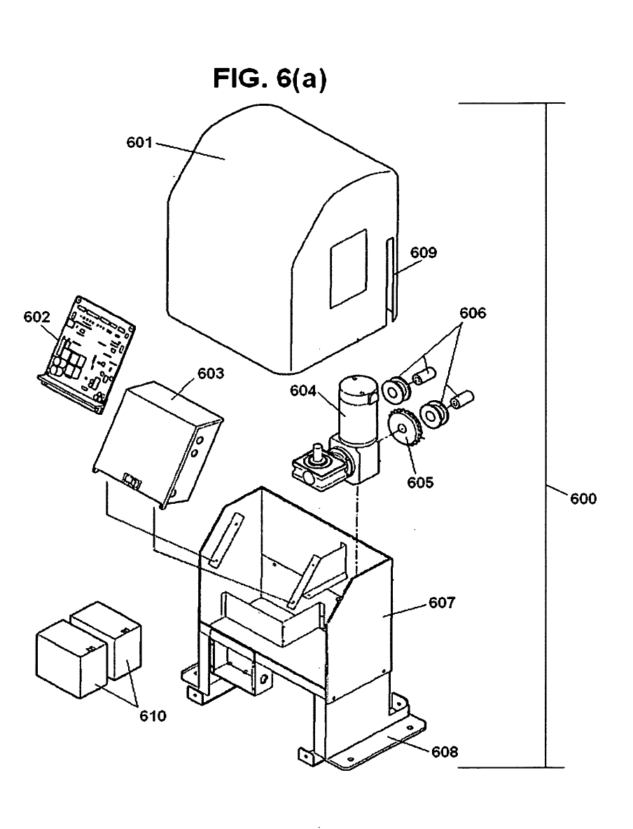

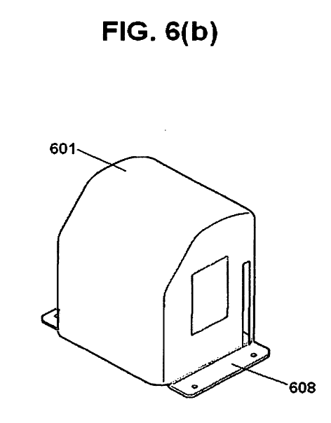

FIG. 6(a) illustrates an embodiment of the present invention in which a photovoltaicly powered movable barrier operator utilizes a chain to actuate a slide gate, comprising an operator housing treated or printed with photovoltaic film to generate an electrical power source.

Movable barrier operator 600 comprises a photovoltaic housing 601, which houses the various working components including control board 602, control box 603, motor 604, batteries 610, and chassis 607, which is used to properly support the various components inside housing 601.

Housing 601 is treated or printed with a thin layer of photovoltaic film and contains a matrix or conduit to supply batteries 610 with a source of electrical power. The electrical power from batteries 610 supply control board 602 and motor 604 with the necessary power for operation.

Instead of including a power interface that connects movable barrier operator 600 to either power lines or some type of generator, housing 601 is simply connected to batteries 610 and placed over chassis 607, as with conventional movable barrier operator casings.

In an exemplary embodiment, movable barrier operator 600 is comparable to gate operator model L-3™ developed by Viking Access Systems™, which has been configured to generate electrical power utilizing a photovoltaic film. In alternative embodiments, other gate operators developed by Viking Access Systems™ may be implemented with the present invention, for example, and without limiting the scope of the present invention, models K-2™, H-10™, F-10™, and R-6™ all have housings with adequate surface area for receiving a light source. Although the housings of such models would need to be reconfigured and adapted properly in accordance with the present invention, the specifications of such exemplary housings may be desirable.

FIG. 6(b) is an illustration of movable barrier 600 with housing 601 properly in place. A gate is coupled to movable barrier 600 by connecting, for example, a chain connected to the gate to sprocket 605 and guiding sprockets 606. Slot 609 is used as an opening to provide for the movement of said chain.

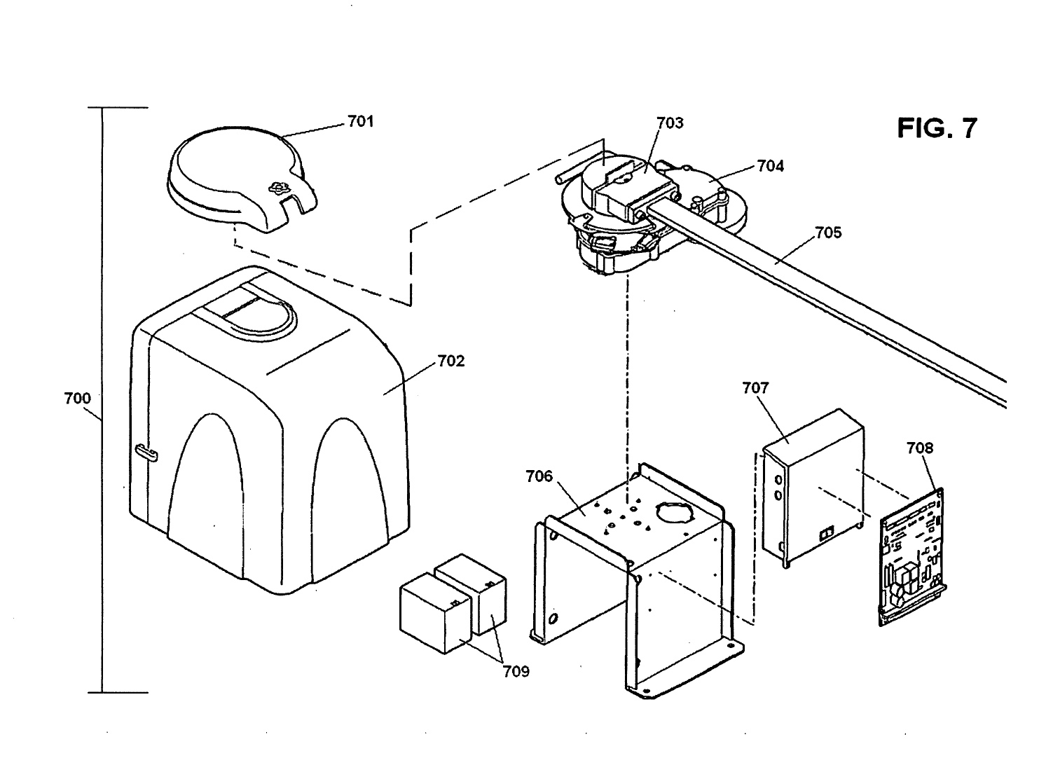

FIG. 7 illustrates an embodiment of the present invention in which a photovoltaicly powered movable barrier operator utilizes an articulated arm to actuate a swing gate, comprising an operator housing treated, or printed, with photovoltaic film to generate an electrical power source.

Movable barrier operator 700 comprises of housing 701 which encases movable barrier operator 700's components, including motor 704, clutch 703, batteries 709, control box 707, and control board 708. Chassis 706 supports the various components inside housing 701.

Typically, housing 701 is a two part housing to allow for movement of articulated arm 705. While some embodiments of housing 701 comprise multiple parts covered in a photovoltaic film, in other embodiments, only a majority of housing 701 is treated with photovoltaic film.

As with movable barrier operator 600, batteries 701 are charged with electrical power generated by housing 701. Instead of including a power interface that connects movable barrier operator 700 to either power lines or some type of generator, housing 701 is simply connected to batteries 709 and placed over chassis 706, as with conventional movable barrier operator casings.

An access operating device equipped with a cover or housing, which has been retrofitted with a photovoltaic film and adapted to convert energy to an electrical power source for powering a movable barrier has been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching. It is intended that the scope of the invention not be limited by this detailed description, but by the claims and the equivalents to the claims.

What is claimed is:

1. An access system, comprising:
a movable barrier;
a sensor;
a motor mechanically coupled to said movable barrier;
a controller adapted to send a control signal to said motor to move said movable barrier in response to a sensing signal received from said sensor;
a battery adapted to supply power to said controller and said motor; and
a housing for enclosing at least said battery and said motor, wherein an external surface of said housing includes a photovoltaic film adapted to supply power to said battery.

2. The access system of claim 1, wherein said housing comprises a casing, and wherein said photovoltaic film is disposed on an exterior surface of said casing.

3. The access system of claim 2, wherein said photovoltaic film further comprises a first connector for connecting to a second connector coupled to said controller, motor, and battery.

4. The access system of claim 3, wherein said first connector further comprises a voltage regulator.

5. The access system of claim 4, wherein said sensor is an inductive sensor.

6. The access system of claim 4, wherein said sensor is an inductive loop sensor.

7. The access system of claim 4, wherein said sensor is an infrared sensor.

8. The access system of claim 4, wherein said motor is a Lorentz force motor.

9. The access system of claim 4, wherein said motor is a Stepper motor.

10. The access system of claim 4, wherein said motor is a DC brushless motor.

11. The access system of claim 4, wherein said motor is an AC motor.

12. The access system of claim 4, wherein said movable barrier is a slide gate.

13. The access system of claim 4, wherein said movable barrier is a swing gate.

14. The access system of claim 4, wherein said movable barrier is a roll-up gate.

15. The access system of claim 4, wherein said first connector further comprises a voltage regulator.

16. A movable barrier operator for an access system, comprising:
a first connector adapted to connect to a sensor;
a motor adapted to be mechanically coupled to a movable barrier;
a controller adapted to send a control signal to said motor to actuate said movable barrier in response to a sensing signal received from said sensor;
a battery adapted to supply power to said controller and motor; and
a housing for enclosing at least said controller, motor and battery, wherein an external surface of said housing includes a photovoltaic film adapted to supply power to said battery, said controller and said motor.

17. The access system of claim 16, wherein said housing comprises a casing, and wherein said photovoltaic film is disposed on an exterior surface of said casing.

18. The access system of claim 17, wherein said photovoltaic film further comprises a first connector for connecting to a second connector coupled to said controller, motor, and battery.

19. The access system of claim 18, wherein said first connector further comprises a voltage regulator.

20. A housing for an access system operator, comprising:
a casing;
a photovoltaic film disposed on at least a portion of an external surface of said casing; and
a connector adapted to route power from said photovoltaic film to one or more devices enclosed within said casing.

21. The housing of claim 20, further comprising a voltage regulator housed within said casing for regulating power supplied to a battery, wherein said battery is for powering a motor enclosed within said housing.

22. The housing of claim 21, wherein said photovoltaic film comprises of flexible and lightweight nano-enabled polymer photovoltaic materials.

23. An access system, comprising:
a movable barrier;
a motor mechanically coupled to said movable barrier;
a controller adapted to send a control signal to said motor to move said movable barrier;
an energy storage device for supplying power to said motor and said controller; and
a housing for enclosing at least said energy storage device and said motor,
wherein said housing further comprises:
a casing, and
a photovoltaic film disposed on an exterior surface of said casing, wherein said photovoltaic film is adapted to recharge said energy storage device.

24. An access system comprising:
a slide gate adapted to move on a track;
a motor;
a sprocket rotably coupled to said motor;
a chain directly coupled to said sprocket and said slide gate in a manner so that said slide gate moves at a substantially the same speed as a rotation speed of said sprocket, wherein said chain runs substantially parallel to said track;
an idle wheel for maintaining said chain mechanically connected to said sprocket;
a controller adapted to control said rotation of said motor;
a sensor connected to said controller, said sensor adapted to generate a signal after detecting a predefined event;
an energy storage device adapted to supply power to said controller and said motor; and
a housing for enclosing at least said energy storage device and said motor,
wherein said housing further comprises:
a casing, and
a photovoltaic film disposed on an exterior surface of said casing, wherein said photovoltaic film is adapted to supply power to said energy storage device.
